(19) United States
(12) Patent Application Publication
(10) Pub. No.: US 2015/0288279 A1
(43) Pub. Date: Oct. 8, 2015

(54) POWER CONVERTER AND DRIVING METHOD FOR THE SAME

(71) Applicant: SAMSUNG ELECTRO-MECHANICS CO., LTD., Suwon-Si (KR)

(72) Inventors: Man Dong LEE, Suwon-si (KR); Seung Kon Kong, Suwon-Si (KR); Hyun Ku Kang, Suwon-Si (KR); Dae Hoon Han, Suwon-Si (KR); Jung Eui Park, Suwon-Si (KR)

(73) Assignee: SAMSUNG ELECTRO-MECHANICS CO., LTD., Suwon-Si (KR)

(21) Appl. No.: 14/572,459

(22) Filed: Dec. 16, 2014

(30) Foreign Application Priority Data
Apr. 3, 2014 (KR) 10-2014-0039972

(51) Int. Cl. H02M 3/156

(52) U.S. Cl. CPC H02M 3/156

(57) ABSTRACT

A power converter and a driving method for the same may prevent a current from flowing excessively during initial driving. The power converter may include an inductor, a switch turned on or turned off according to a control signal to control a current flowing through the inductor, and a control unit detecting the magnitude of the current flowing through the switch, outputting the control signal for controlling the turn-on/turn-off operation of the switch, setting a reference current and turning off the switch during a preset first time when the current flowing through the switch reaches the reference current during initial driving.

### CROSS-REFERENCE TO RELATED APPLICATIONS

This application claims the benefit under 35 U.S.C. Section 119 of Korean Patent Application Serial No. 10-2014-0039972, entitled filed Apr. 3, 2014, which is hereby incorporated by reference in its entirety into this application.

### BACKGROUND

1. Technical Field

Some embodiments of the present invention generally relates to a power converter and a driving method for the same.

2. Description of the Related Art

In general, switch mode power supplies such as buck converters and flyback converters are used in a wide range of electronic equipment. Further, there are recent trends to develop techniques of reducing energy consumption by reducing power consumption. In order to reduce power consumption of the switch mode power supplies, it is needed to reduce unnecessary current consumption. In particular, the switch mode power supply may require a higher current than a preset current when a switch is turned on to stably generate and supply the preset current, but an excessive current may flow during initial driving. Further, the higher the magnitude of the current flowing during the initial driving, the longer the time required for the initial driving. Thus, the time for starting normal driving may be delayed.

### SUMMARY

Some embodiments of the present invention may provide a power converter and a driving method for the same that can prevent a current from flowing excessively during initial driving.

Some embodiments of the present invention may provide a power converter and a driving method for the same that can start a normal operation quickly by reducing an initial driving time.

In accordance with some embodiments of the present invention, a power converter may include an inductor, a switch turned on or turned off according to a control signal to control the flow of a current flowing through the inductor, and a control unit outputting the control signal for controlling a turn-on/turn-off operation of the switch by setting a reference current and detecting a magnitude of a current flowing through the switch. The control unit may be configured to turn off the switch during a preset first time when the current flowing through the switch reaches a reference current during initial driving, to turn on the switch during a normal operation so that the current flowing through the switch exceeds the reference current, and to turn off the switch during a preset second time to reduce the current flowing through the switch than the reference current.

In accordance with some embodiments of the present invention, a power converter may comprise an inductor, a switch turned on or turned off according to a control signal to control the flow of a current flowing through the inductor, and a control unit for controlling the magnitude of the current flowing through the inductor by controlling the switch. The control unit may determine the turn-on/turn-off operation of the switch by detecting the current flowing through the switch, the current flowing through the switch may have a plurality of peak values, and at least a first peak value of the plurality of peak values may be controlled to be the magnitude of a reference current.

In accordance with some embodiments of the present invention, a driving method for a power converter, which adjusts a current flowing through an inductor by controlling turn-on/turn-off of a switch, may comprise steps of detecting a current flowing through the switch and turning off the switch during a preset first time when the magnitude of the current flowing through the switch reaches the magnitude of a preset reference current, and turning on the switch and turning off the switch during a preset second time to reduce the current flowing through the switch to the magnitude of the reference current when the current flowing through the switch exceeds the magnitude of the reference current.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a circuit diagram showing a power converter in accordance with an embodiment of the present invention;

FIG. 2 is a circuit diagram showing an embodiment of a control unit employed in the power converter shown in FIG. 1;

FIG. 3 is a timing diagram showing a first embodiment of the operation of the power converter shown in FIG. 1;

FIG. 4 is a timing diagram showing a second embodiment of the operation of the power converter shown in FIG. 1; and

FIG. 5 is a flowchart showing an embodiment of the operation of the power converter shown in FIG. 1.

### DETAILED DESCRIPTION OF THE PREFERABLE EMBODIMENTS

A matter regarding to an operational effect including a technical configuration for an object of a power converter and a driving method for the same in accordance with the present invention will be clearly appreciated through the following detailed description with reference to the accompanying drawings showing preferable embodiments of the present invention.

Further, in describing the present invention, descriptions of well-known techniques are omitted so as not to unnecessarily obscure the embodiments of the present invention. In the present specification, the terms “first,” “second,” and the like are used for distinguishing one element from another, and the elements are not limited by the above terms.

In the following detailed description of the present invention, reference is made to the accompanying drawings that show, by way of illustration, specific embodiments in which the present invention may be practiced. These embodiments are described in sufficient detail to enable those skilled in the art to practice the embodiments. It is to be understood that the various embodiments, although different, are not necessarily mutually exclusive. For example, a particular feature, structure, or characteristic described herein, in connection with one embodiment, may be implemented within other embodiments without departing from the spirit and scope of the embodiments. In addition, it is to be understood that the location or arrangement of individual elements within each disclosed embodiment may be modified without departing from the spirit and scope of the embodiments. The following detailed description is, therefore, not to be taken in a limiting sense, and the scope of the embodiments is defined only by the appended claims, appropriately interpreted, along with the full range of equivalents to which the claims are entitled. In the drawings, like numerals refer to the same or similar functionality throughout the several views.

Hereinafter, embodiments of the present invention will be described in detail with reference to the accompanying drawings so that those skilled in the art can easily practice the present invention.

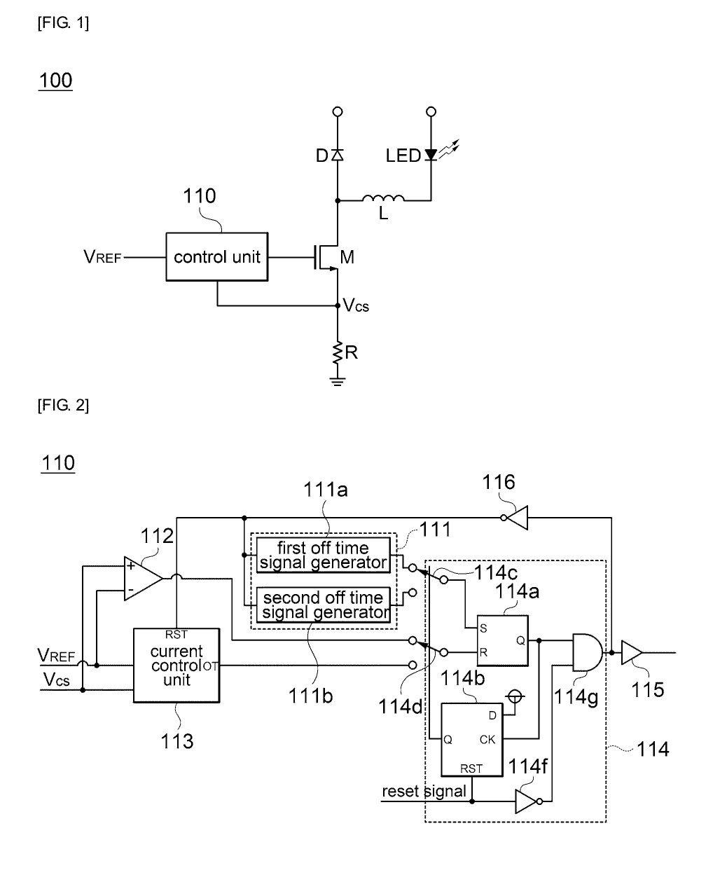

FIG. 1 is a circuit diagram showing a power converter in accordance with an embodiment of the present invention.

Referring to FIG. 1, a power converter 100 may include an inductor L, a switch M, and a control unit 110. The switch M may be turned on or turned off according to a control signal to control the flow of a current flowing through the inductor L. The control unit 110 may turn off the switch M during a preset first time when a current flowing through the switch M reaches a reference current during initial driving, turn on the switch M during a normal operation in order for the current flowing through the switch M to exceed the reference current, and turn off the switch M during a preset second time to reduce the current flowing through the switch M than the reference current while outputting the control signal for controlling the turn-on/turn-off operation of the switch M by setting the reference current and detecting the magnitude of the current flowing through the switch M. The power converter 100 may further include a light emitting diode LED and a rectifier including a diode D, and a current may flow through the light emitting diode LED according to the operation of the switch M to emit light.

The inductor L may be connected to the switch M, and a predetermined voltage may be generated by flowing or blocking the current according to the turn-on or turn-off operation of the switch M.

One end of the switch M may be connected to the inductor L and the other end of the switch M may be connected to a resistor R. The turn-on/turn-off operation of the switch M may be determined according to the control signal from the control unit 110. The switch M may be a transistor such as a MOS transistor, and the control signal may be transmitted to a gate of the transistor to control the turn-on/turn-off operation of the transistor when the switch M is a transistor.

The control unit 110 may detect the magnitude of the current flowing through the switch M and output the control signal for controlling the turn-on/turn-off operation of the switch M. For this, the control unit 110 may compare a voltage V_{CS} generated by the current flowing through the resistor R connected to the switch M with a preset reference voltage V_{REF}, and output the control signal according to the result of the comparison. A pulse width of the control signal may be adjusted, and the current flowing through the switch M may be adjusted by adjusting a turn-on time and a turn-off time of the switch M according to the pulse width of the control signal. To prevent an excessive current flowing through the inductor L during the initial driving, the control unit 110 may block the current flowing through the switch M during a predetermined time by turning off the switch M during the preset first time when the current flowing through the switch M reaches the reference current. And, the control unit 110 may turn on the switch M after the preset first time to start the normal operation, and then turn off the switch M again to reduce the current flowing through the switch M when the current flowing through the switch M exceeds the reference current. The control unit 110 may turn off the switch M during the preset second time to reduce the current flowing through the switch M. The control unit 110 may control the current flowing through the switch M by the turn-on/turn-off operation of the switch M to have a plurality of peak values and control at least a first peak value of the plurality of peak values to be the magnitude of the reference current. That is, it is possible to prevent the excessive current flowing through the switch M by controlling the turn-on/turn-off operation of the switch M by the control unit 110 so that the peak value of the current initially flowing through the switch M does not exceed the reference current in the initial stage. The predetermined voltage may be generated in the inductor L when the increase and decrease of the current flowing through the inductor L are repeated by the repetition of the turn-on/turn-off operation of the switch M by the control unit 110.

In the embodiment, the magnitude of the reference current may be an average value of the current flowing through the switch M during the normal operation. Therefore, the predetermined voltage may be generated in the inductor L by the current with the magnitude of the reference current during the normal operation. Further, the light emitting diode LED may have a brightness corresponding to the reference current.

In the embodiment, the control unit 110 may control the preset first time to be shorter than the preset second time. If the preset first time is shorter than the preset second time, a speed to reach a second peak value is increased and thus it is possible to reach a normal state quickly.

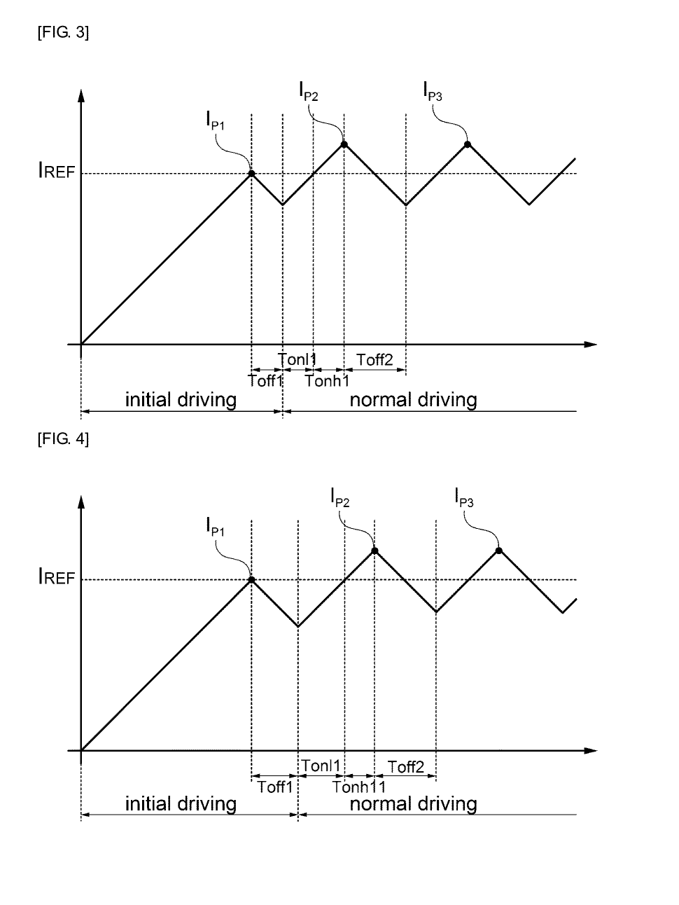

FIG. 2 is a circuit diagram showing an embodiment of the control unit employed in the power converter shown in FIG. 1, FIG. 3 is a timing diagram showing a first embodiment of the operation of the power converter shown in FIG. 1, and FIG. 4 is a timing diagram showing a second embodiment of the operation of the power converter shown in FIG. 1.

Referring to FIGS. 2 to 4, the control unit 110 may include an off time signal generator 111. The off time signal generator 111 may include a first off time signal generator 111a and a second off time signal generator 111b. The first off time signal generator 111a and the second off time signal generator 111b may set different periods for which the off time of the switch M is maintained and store the periods. Further, the first off time signal generator 111a may store a first time T_{off1} for which the off time of the switch M is maintained during the initial driving, and the second off time signal generator 111 b may store a second time T_{off2} for which the off time of the switch M is maintained during the normal operation. That is, the control unit 110 may turn off the switch M during the first time T_{off1} when the current flowing through the switch M reaches the reference current during the initial driving to reduce the current flowing through the switch M. And, the control unit 110 may generate the control signal for turning on the switch M after the first time T_{off1}, set to the first off time signal generator 111a, during the normal operation to increase the current flowing through the switch M. And the control unit 110 may turn off the switch M during the second time T_{off2}, set to the second off time signal generator 111b, after a predetermined time after or when the current flowing through the switch M reaches the reference current in order to reduce the current flowing through the switch M. And the control unit 110 may generate the control signal for turning on the switch M after the second time T_{off2} to increase the current flowing through the switch M. Therefore, the control unit 110 can change the current flowing through the inductor L by adjusting the current flowing through the switch M by the control of the turn-on/turn-off operation of the switch M.

In the embodiment, the control unit 110 may further include a current control unit 113. The current control unit 113 may detect the magnitude of the current flowing through the switch M to generate the signal for turning off the switch M according to the detected magnitude of the current. The current control unit 113 may generate the signal for turning off the switch M to block the switch M when the switch M is turned on and the magnitude of the current flowing through the switch M is increased to above the magnitude of the reference current from below a reference value. For this, the current control unit 113 may receive the measured voltage V_{CS} generated by the resistor R, in which the current flowing through the switch M flows, and the reference voltage V_{REF}.

In the embodiment, the control unit 110 may further include a comparator 112. The comparator 112 may determine whether the current flowing through the switch M reaches the reference current and output the signal for turning off the switch M when the current flowing through the switch M reaches the reference current.

In the embodiment, the control unit 110 may further include a selection unit 114. The selection unit 114 may select one of the outputs of the current control unit 113 and the comparator 112 to output the selected output as the control signal, and transmit the control signal to the switch M. Further, the selection unit 114 may select one of the first off time signal generator 111a and the second off time signal generator 111b. The selection unit 114 may include an output state setting device 114a, an initial operation setting device 114b, and a logic gate 114g. The output state setting device 114a may receive signals through two input terminals. A first input terminal of the output state setting device 114a may be connected to the first off time signal generator 111a or the second off time signal generator 111b, and a second input terminal of the output state setting device 114a may be connected to the current control unit 113 or the comparator 112. The output state setting device 114a may be, for example, but not limited to, an RS flip-flop. The initial operation setting device 114b may select signals input to the two input terminals of the output state setting device 114a. By the initial operation setting device 114b, one of the first off time signal generator 111a and the second off time signal generator 111b may be connected to the first input terminal of the output state setting device 114a, and one of the comparator 112 and the current control unit 113 may be connected to the second input terminal of the output state setting device 114a. The initial operation setting device 114b may be, for instance, but not limited to, a D flip-flop. The logic gate 114g may output the control signal for turning on or turning off the switch M based on two inputs which are an output of the output state setting device 114a and a reset signal. The output of the output state setting device 114a input to the logic gate 114g may be changed by the off time signal generator 111, the comparator 112, and/or the current control unit 113, but the reset signal input to the logic gate 114g may be changed in a specific condition. For example, the reset signal input to the logic gate 114g may be a signal obtained by inverting a reset signal of a second selector, for example, the initial operation setting device 114b, through a first inverter 114f. An output signal of the logic gate 114g may be transmitted to the off time signal generator 111 through a second inverter 116 and used as a reset signal of the current control unit 113. Further, the output signal of the logic gate 114g may be transmitted to the switch M through a buffer 115. The logic gate 114g may be, for instance, but not limited to, an AND gate. Further, the first input terminal of the output state setting device 114a may be connected to a first MUX 114c, and the second input terminal of the output state setting device 114a may be connected to a second MUX 114d. The first MUX 114c may select one of the first off time signal generator 111a and the second off time signal generator 111b by the initial operation setting device 114b, and the second MUX 114d may select one of the comparator 112 and the current control unit 113 by the initial operation setting device 114b.

The operation of the control unit 110 configured as above will be described below.

For example, the first off time signal generator 111a and the comparator 112 may be selected by the initial operation setting device 114b and respectively connected to the output state setting device 114a during the initial driving. When the switch M is turned on, the current flowing through the switch M may be increased as shown in FIG. 3 or 4. At this time, since the first off time signal generator 111a and the comparator 112 may be selected by the initial operation setting device 114b, an output of the first off time signal generator 111a may be transmitted to the first input terminal of the output state setting device 114a, and an output of the comparator 112 may be transmitted to the second input terminal of the output state setting device 114a. When the current flowing through the switch M is increased to the magnitude of the reference current I_{REF}, the comparator 112 may compare the measured voltage V_{CS} formed in the resistor R by the current flowing through the switch M with the reference voltage V_{REF} to output the signal for turning off the switch M. Therefore, the output of the comparator 112 may be transmitted to the switch M by the output state setting device 114a so that the switch M may be turned off and the current flowing through the switch M may be reduced. Because of the above reasons, a first peak value I_{P1} of the current flowing through the switch M during the initial driving cannot exceed the magnitude of the reference current I_{REF}. And since the switch M is turned off during the first time T_{off1} set to the first off time signal generator 111a, the current flowing through the switch M can be reduced during the first time T_{off1}.

When the first time T_{off1} set to the first off time signal generator 111a is passed, the signal for turning on the switch M may be input to the first input terminal of the output state setting device 114a. When the signal for turning on the switch M is input to the first input terminal of the output state setting device 114a, the output state setting device 114a can output the signal for turning on the switch M and thus the logic gate 114g can output the control signal for turning on the switch M. Due to this, the current flowing through the switch M can be increased again.

The second off time signal generator 111b and the current control unit 113 may be selected by the initial operation setting device 114b during the normal operation. When the second off time signal generator 111b and the current control unit 113 are selected, an output of the second off time signal generator 111b may be transmitted to the first input terminal of the output state setting device 114a, and an output of the current control unit 113 may be transmitted to the second input terminal of the output state setting device 114a. When the switch M is turned on and the current flowing through the switch M is increased and exceeds the reference current I_{REF} to a second peak value Ip2, the current control unit 113 may output the signal for turning off the switch M corresponding to the measured voltage V_{CS} formed in the resistor R and the reference voltage V_{REF}.

Therefore, the output of the current control unit 113 can be transmitted to the switch M by the output state setting device 114a so that the switch M can be turned off and the current flowing through the switch M can be reduced. Due to the above reasons, the second peak value I_{P2} flowing through the switch M during the normal operation can exceed the magnitude of the reference current I_{REF}. At this time, a ratio of a first period Tₒₙₗ₁ in which the switch M is turned on and the current is below the reference current I_{REF} and a second period Tₒₙₗ₁ in which the current exceeds the reference current and reach the peak value I_{P2} during the normal operation may be 1:1 as shown in FIG. 3 or 1:1.5 as shown in FIG. 4. Here, the ratio of the first period Tₒₙₗ₁ and the second period Tₒₙₗ₁ is shown as 1:1 or 1:1.5, but the ratio of the first period Tₒₙₗ₁ and the second period Tₒₙₗ₁ is not limited thereto.

And when the second time T_{off2} set to the second off time signal generator 111b is passed, the signal for turning on the switch M may be input to the first input terminal of the output state setting device 114a. When the signal for turning on the switch M is input to the first input terminal of the output state setting device 114a, the output state setting device 114a can output the signal for turning on the switch M so that the logic gate 114g can output the control signal for turning on the switch M. Due to this, the current flowing through the switch M can be increased again.

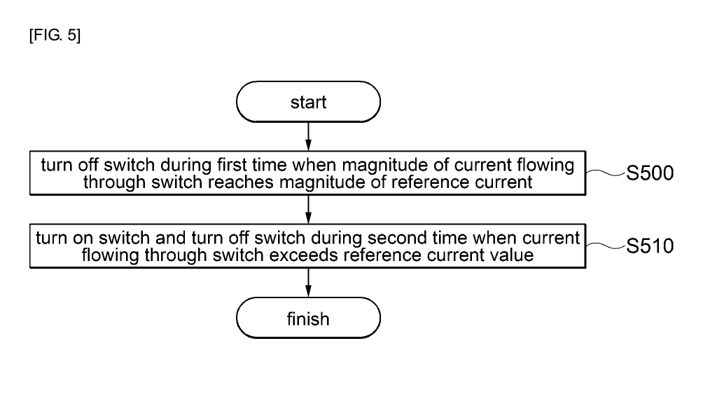

FIG. 5 is a flowchart showing an embodiment of the operation of the power converter shown in FIG. 1.

Referring to FIG. 5, a driving method of a power converter 100 for adjusting a current flowing through an inductor L by controlling turn-on/turn-off of a switch M may detect the current flowing through the switch M and turn off the switch M during a preset first time when the magnitude of the current flowing through the switch M reaches the magnitude of a preset reference current (S500). And the switch M may be turned on and then turned off during a preset second time when the current flowing through the switch M exceeds the magnitude of the reference current, thus reducing the current flowing through the switch M than the magnitude of the reference current (S510).

In the embodiment, the reference current may be an average current of the current flowing through the switch M.

In the embodiment of the driving method of the power converter 100, the preset first time may be shorter than the preset second time. When the preset first time is implemented shorter, the time for which the current is reduced during initial driving can be reduced to start a normal operation quickly.

Some embodiments of the power converter and the driving method for the same according to the present invention can reduce power consumption by preventing an excessive current from flowing during initial driving. Further, it is possible to start a normal operation quickly by reducing an initial driving time.

The functions of the various elements shown in the drawings may be provided through the use of dedicated hardware as well as hardware capable of executing software in association with appropriate software. When provided by a processor, the functions may be provided by a single dedicated processor, by a single shared processor, or by a plurality of individual processors, some of which may be shared.

In the claims hereof, any element expressed as a means for performing a specified function is intended to encompass any way of performing that function including, for example, a combination of circuit elements which performs that function or software in any form, including, therefore, firmware, microcode or the like, combined with appropriate circuitry for executing that software to perform the function.

Reference in the specification to “an embodiment” of the present principles, as well as other variations thereof, means that a particular feature, structure, characteristic, and so forth described in connection with the embodiment is included in at least one embodiment of the present principles. Thus, the appearances of the phrase “in an embodiment”, as well as any other variations, appearing in various places throughout the specification are not necessarily all referring to the same embodiment.

Reference in the specification to “connect” or “connecting”, as well as other variations thereof, means that an element is directly connected to the other element or indirectly connected to the other element through another element. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

What is claimed is:

1. A power converter comprising:
an inductor;
a switch turned on or turned off according to a control signal to control a current flowing through the inductor; and
a control unit outputting the control signal for controlling a turn-on/turn-off operation of the switch by setting a reference current and detecting a magnitude of a current flowing through the switch,
wherein the control unit is configured to turn off the switch during a preset first time when the current flowing through the switch reaches a reference current during initial driving, to turn on the switch during a normal operation so that the current flowing through the switch exceeds the reference current, and to turn off the switch during a preset second time to reduce the current flowing through the switch than the reference current.

2. The power converter according to claim 1, wherein the magnitude of the reference current is an average value of the current flowing through the switch during the normal operation.

3. The power converter according to claim 1, wherein the control unit controls the preset first time to be shorter than the preset second time.

4. The power converter according to claim 1, wherein the control unit comprises a first off time signal generator and a second off time signal generator, the preset first time is set in the first off time signal generator and the preset second time is set in the second off time signal generator, and one of the first off time signal generator and the second off time signal generator is selected to determine an off time of the switch.

5. The power converter according to claim 1, wherein the control unit further comprises a current control unit, wherein the current control unit is configured to generate a signal for turning off the switch during the normal operation so that the switch is turned off during the preset second time to reduce a minimum value of the current flowing through the switch to the reference current when the current flowing through the switch exceeds a reference value.

6. The power converter according to claim 1, wherein the control unit further comprises a comparator, wherein the comparator determines whether the current flowing through the switch reaches the reference current and the switch is turned off in response to an output of the comparator when the current flowing through the switch reaches the reference current.

7. The power converter according to claim 1, wherein:
the control unit further comprises a current control unit, a comparator, and a selection unit,
the current control unit is configured to generate a signal for turning off the switch during the normal operation so that the switch is turned off during the preset second time to reduce a minimum value of the current flowing through the switch to the reference current when the current flowing through the switch exceeds a reference value,
the comparator determines whether the current flowing through the switch reaches the reference current and the switch is turned off in response to an output of the comparator when the current flowing through the switch reaches the reference current, and
the selection unit selects one of outputs of the current control unit and the comparator to transmit the selected output to the switch.

8. The power converter according to claim 7, wherein the control unit comprises a first off time signal generator and a second off time signal generator, the preset first time is set in the first off time signal generator and the preset second time is set in the second off time signal generator, and one of the first off time signal generator and the second off time signal generator is selected by the control signal to determine an off time of the switch, and
the selection unit further selects one of outputs of the first off time signal generator and the second off time signal generator.

9. The power converter according to claim 1, wherein a period in which the switch is turned on during the normal operation is divided into a first period in which the magnitude of the current flowing through the switch is less than a reference value and a second period in which the magnitude of the current flowing through the switch is greater than the reference value, and the control unit configured to control a length of the first period to be substantially equal to a length of the second period.

10. The power converter according to claim 2, wherein a period in which the switch is turned on during the normal operation is divided into a first period in which a magnitude of the current flowing through the switch is less than a reference value and a second period in which the magnitude of the current flowing through the switch is greater than the reference value, and the control unit is configured to control a length of the first period to be longer than a length of the second period.

11. A power converter comprising:
an inductor;
a switch turned on or turned off according to a control signal to control a current flowing through the inductor; and
a control unit configured to control a magnitude of the current flowing through the inductor by controlling the turn-on/turn-off of the switch, wherein the control unit determines a turn-on/turn-off operation of the switch by detecting a current flowing through the switch, the current flowing through the switch has a plurality of peak values, and at least a first peak value of the plurality of peak values is controlled to be a magnitude of a reference current.

12. The power converter according to claim 11, wherein the control unit turns off the switch when the peak values from at least a second peak exceed the magnitude of the reference current.

13. The power converter according to claim 12, wherein the control unit controls a level of the second peak of the current flowing through the switch to be higher than the reference current and controls a minimum value of the current flowing through the switch to be lower than the reference current.

14. The power converter according to claim 11, wherein a period in which the switch is turned on and reaches one of the peak values is divided into a first period in which a magnitude of the current flowing through the switch is less than a reference value and a second period in which the magnitude of the current flowing through the switch is greater than the reference value and the control unit is configured to control a length of the first period to be substantially equal to a length of the second period.

15. The power converter according to claim 11, wherein a period in which the switch is turned on and reaches one of the peak values is divided into a first period in which the magnitude of the current flowing through the switch is less than a reference value and a second period in which the magnitude of the current flowing through the switch is greater than the reference value, and the control unit is configured to control a length of the first period to be longer than a length of the second period.

16. The power converter according to claim 11, wherein a magnitude of the reference current is set to an average magnitude of the current flowing through the switch between a second peak value and a third peak value of the plurality of peak values.

17. A driving method for a power converter, which adjusts a current flowing through an inductor by controlling turn-on/turn-off of a switch, comprising:
detecting a current flowing through the switch and turning off the switch during a preset first time when a magnitude of the current flowing through the switch reaches a magnitude of a preset reference current; and
turning on the switch and turning off the switch during a preset second time to reduce the current flowing through the switch to the magnitude of the reference current when the current flowing through the switch exceeds the magnitude of the reference current.

18. The driving method for the power converter according to claim 17, wherein the magnitude of the reference current is a magnitude of an average current of the current flowing through the switch.

19. The driving method for the power converter according to claim 17, wherein the preset first time is shorter than the preset second time.
